(19) United States
(12) Patent Application Publication
(10) Pub. No.: US 2014/0253403 A1
(43) Pub. Date: Sep. 11, 2014

(54) Low Profile Double-Ridged Horn Antenna For Mobile Communications

(71) Applicant: Benjamin F. Walpole, Murrieta, CA (US)

(72) Inventor: Benjamin F. Walpole, Murrieta, CA (US)

(21) Appl. No.: 13/792,003

(22) Filed: Mar. 9, 2013

(51) Int. Cl. H01Q 13/02

(52) U.S. Cl. CPC H01Q 13/0275
USPC 343/786

(57) ABSTRACT

A broadband double-ridged low profile horn antenna is particularly useful for communications in a mobile wireless network. The broadband antenna of the invention is especially suited for being mounted on the rooftop of a train or vehicle. It is capable of directing electromagnetic energy in a desired direction to provide signal gain. It is capable of conforming to the surface of a vehicle to function aerodynamically. Advantageously, the single broadband double-ridged horn antenna hereof replaces multiple narrowband antennas. This broadband antenna is capable of steering electromagnetic energy in a predetermined direction to provide signal gain toward a pole-mounted communications node located along train tracks, Furthermore, the broadband antenna hereof is made aerodynamic by at least partially conforming it to the exterior rooftop surface of a train or vehicle.

### BACKGROUND OF THE INVENTION

1. Field Of The Invention

The present invention relates generally to the field of communications antennas and particularly to such antennas used on trains and other vehicles. The present invention relates more specifically to a broadband, low profile, double-ridged horn antenna for communications in a mobile wireless network.

2. Background Art

Wireless communications on trains are presently accomplished by transmitting and receiving from multiple high gain antennas on the roof of a train to pole mounted communication nodes usually located adjacent to the train tracks. Current methods to accomplish this use multiple antennas mounted on the train rooftop, one antenna for each communication frequency band. Some of the major bands of interest are 2.4 GHz, 3.6 GHz, 4.9 GHz, and 5.8 GHz. 2.4 and 5.8 GHz are Wi-Fi bands and 3.6 and 4.9 GHz are maintenance and emergency bands. Each antenna must have sufficient gain to maintain adequate signal level and also be tilted at an angle of approximately 15 degrees to maximize the level of the signal received from the pole mounted communication node. Also, because the maximum signal level might be to the rear of the train (at the moment the train passes a pole communications node), four more antennas may be mounted behind the forward looking antennas resulting in a cumbersome configuration of up to eight antennas.

It is desirable that a broadband antenna be provided to consolidate multiple vehicle mounted antennas into one broadband antenna. It is also desirable to develop an antenna that can maintain an aerodynamic form to reduce the wind drag associated with externally mounted antennas on vehicles. Furthermore, it is desirable to steer energy in a desired direction to increase system signal levels.

### SUMMARY OF THE INVENTION

The present invention provides a broadband double-ridged low profile horn antenna for communications in a mobile wireless network. The single broadband antenna of the invention is especially suited for being mounted on the rooftop of a train or vehicle. It is capable of directing electromagnetic energy in a desired direction to maximize signal gain. It is capable of conforming to the surface of a vehicle to function aerodynamically. Advantageously, the single broadband double-ridged horn antenna hereof replaces multiple narrowband antennas. This broadband antenna is capable of steering electromagnetic energy in a predetermined direction to maximize signal gain to a pole-mounted communications node located along train tracks. Furthermore, the broadband antenna remains aerodynamic by at least partially conforming to the exterior rooftop surface of a train or vehicle.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a partially cutaway side view of a conventional prior art broadband double-ridged horn antenna;

FIG. 2 is a front view of the conventional prior art broadband double-ridged horn antenna of FIG. 1;

FIG. 3 is a partially cutaway side view of a low profile broadband, double-ridged horn antenna in accordance with a preferred embodiment of the present invention;

FIG. 4 is a front view of the low profile broadband double-ridged horn antenna embodiment;

FIG. 5 is a side view of two low profile double-ridged horn antennas mounted back-to-back;

FIG. 6 shows a radiation pattern of the preferred embodiment in elevation at 2.4 GHz;

FIG. 7 shows a similar radiation pattern at 3.6 GHz;

FIG. 8 shows a similar radiation pattern at 4.9 GHz; and

FIG. 9 shows a similar radiation pattern at 5.8 GHz.

### DETAILED DESCRIPTION OF PREFERRED EMBODIMENTS

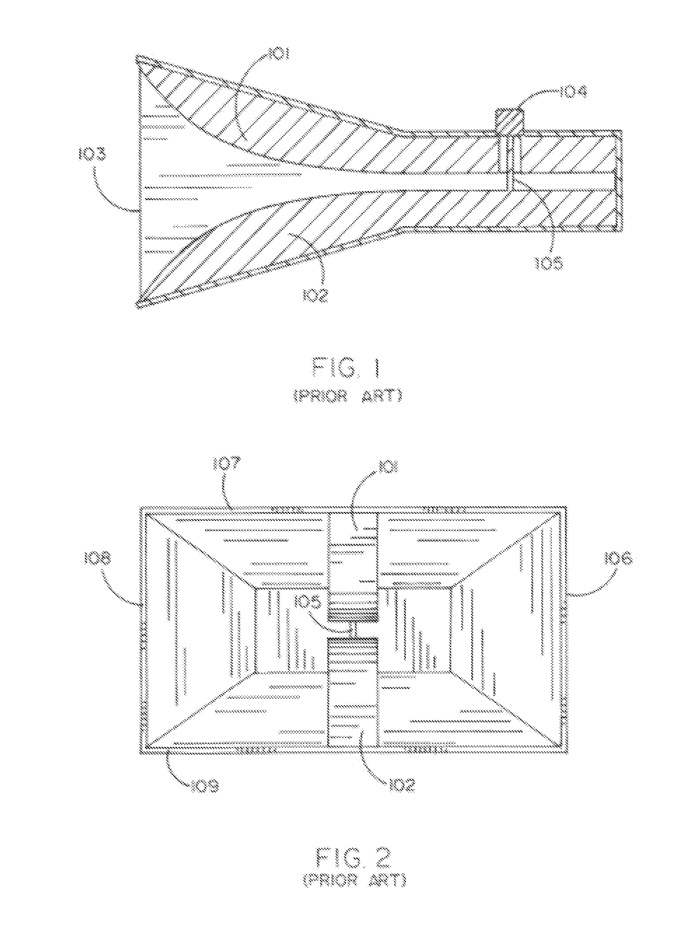

A double-ridged horn antenna or dual ridged horn antenna is a linearly polarized broadband pyramidal antenna. The inclusion of ridges in a horn antenna increases the frequency bandwidth of a horn by lowering the dominant mode cutoff frequency (TE10) and increasing the higher order mode cutoff frequency (TE20 is the first higher order mode). FIGS. 1 and 2 are side and front views of a conventional double-ridged broadband horn antenna. The operating principle of a double-ridged broadband horn antenna will be described with reference to FIG& 1 and 2. The upper and lower horn walls 107 and 109 and the right and left horn walls 106 and 108 (the flared parts of the horn antenna) are configured to transmit electromagnetic signals and maintain the proper shape of the antenna. Energy is coupled from the connector 104 and probe 105 to the upper ridge 101 and to the lower ridge 102. The energy propagates between the ridges 101 and 102 towards the aperture 103 of the horn antenna. The spacing between upper and lower ridges 101 and 102 increases as the distance from the connector 104 increases. The spacing increases according to a taper which is usually exponential, but may also be parabolic or linear. This taper establishes a smooth impedance transition from the connector 104, which is commonly 50 ohms, to free space impedance of 377 ohms.

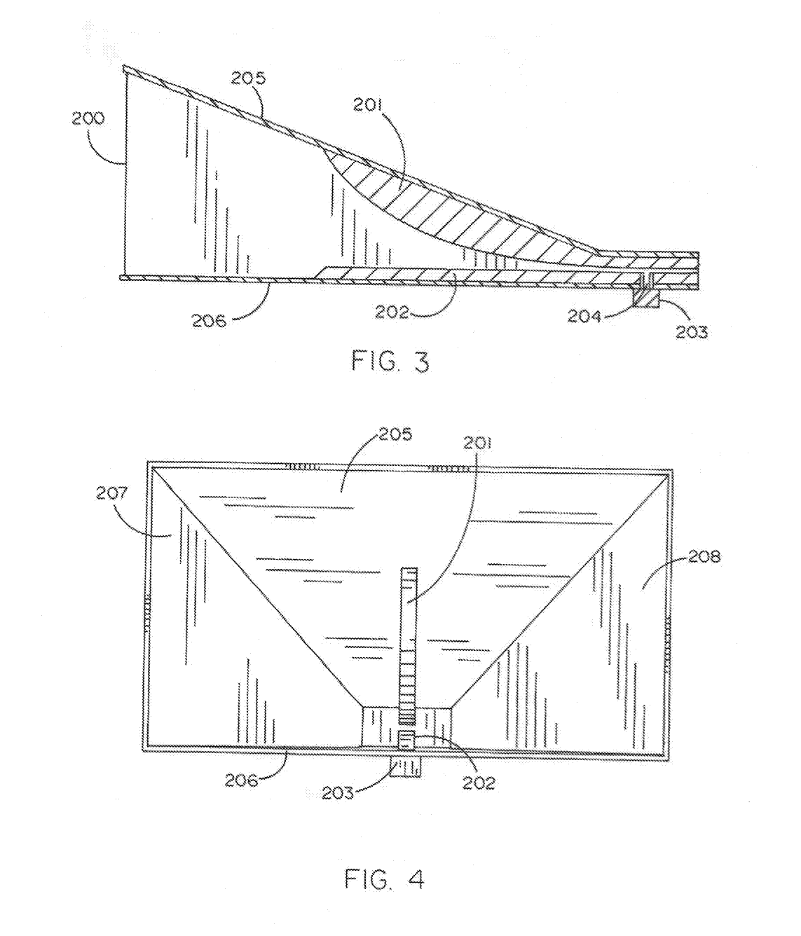

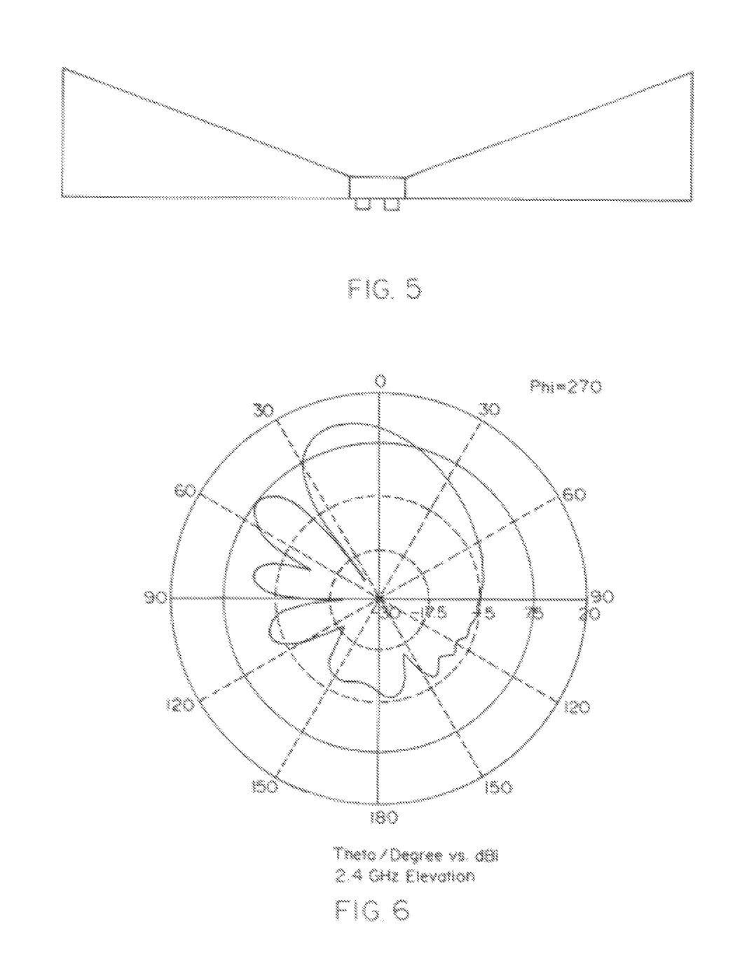

FIG. 3 is a partially cutaway side view of a low profile broadband double-ridged horn antenna. FIG. 4 is a front view of a low profile broadband double-ridged horn antenna according to the design principles of the present invention. FIG. 5 is a side view of two low profile horn antennas mounted back-to-back.

Referring to FIGS. 3 through 5, it will be seen that a low profile broadband double-ridged horn antenna comprises an upper ridge 201 and a lower ridge 202, each configured opposite the other within the antenna. The upper ridge 201 and lower ridge 202 have a straight outer surface which attaches respectively to the upper horn wall 205 and lower horn wall 206. The upper ridge 201 and lower ridge 202 are excited with a probe 204 which is attached to a connector 203. In some cases the upper and lower ridges 201 and 202 may be excited via a waveguide. The upper ridge 201 and lower ridge 202 terminate respectively into the upper horn wall 205 and lower horn wall 206. Energy is coupled from the probe 204 to the upper ridge 201 and lower ridge 202 and the energy is propagated in the direction of the horn aperture 200.

The lower ridge 202 remains of uniform height and abruptly terminates into the lower horn wall 206 at a distance far enough away from the coupling probe 204 such that the lower ridge 202 has no effect on the radiation properties of the low profile double ridged horn antenna. The distance along wall 206 at which the lower ridge 202 terminates, must be such that the dominant mode (lowest propagation mode TE 10) can freely propagate inside the antenna. This propagation is accomplished when the distance between horn sidewalls 207 and 208 (see FIG. 4) is at least 0.5 wavelengths at the lowest frequency of operation. Once this distance criterion has been satisfied, the lower horn ridge 202 may terminate abruptly into the lower horn wail 206.

The upper ridge 201 tapers in the direction of the horn aperture 200 until terminating into the upper horn wall 205. An exponential taper is commonly used in practice to maintain a smooth impedance transformation from the connector 203 to the horn aperture 200. Although an exponential taper is commonly utilized, this taper may take any shape to accomplish the impedance transformation. Other common ridge shapes employ parabolic and linear tapers. The upper horn ridge 201 must also terminate only when the distance between the left horn wall 207 and the right horn wall 208 is at least 0.5 wavelengths at the lowest frequency of operation. As the upper ridge 201 tapers and the lower ridge 202 remains uniform, the energy which is tightly bound between the upper and lower ridges 201 and 202, is steered upwards. At the point at which dominant mode propagation can occur, the energy propagating between the upper ridge 201 and lower ridge 202 detaches and propagates into free space at an elevated angle. This angle of propagation is dependent on the upper ridge taper and is found empirically using three-dimensional electromagnetic simulation software. One skilled in the art may adjust the slope of the taper to steer the elevation beam to a desired angle.

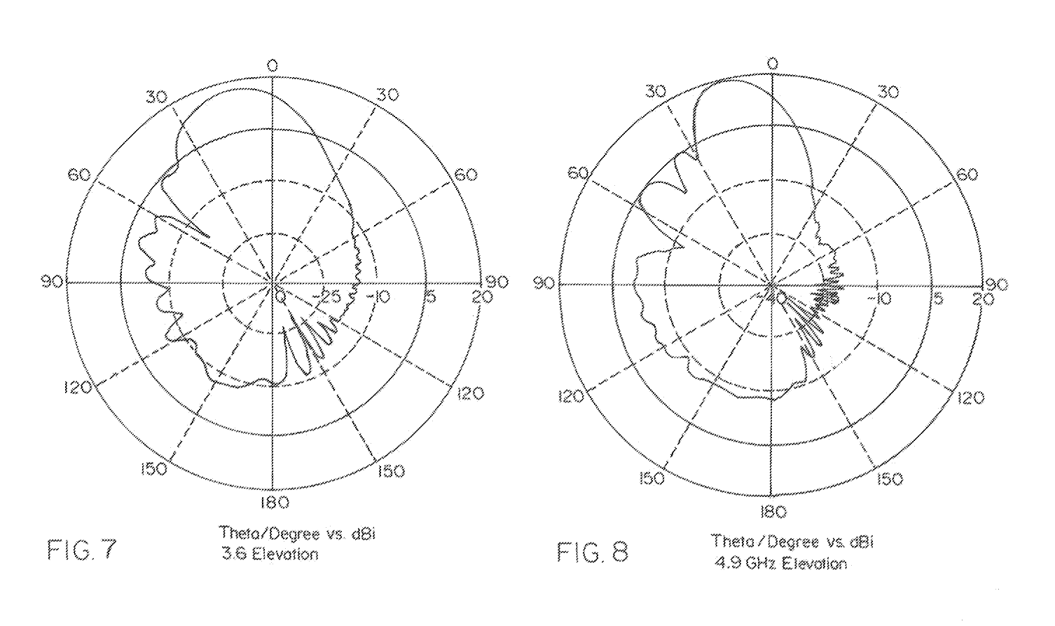

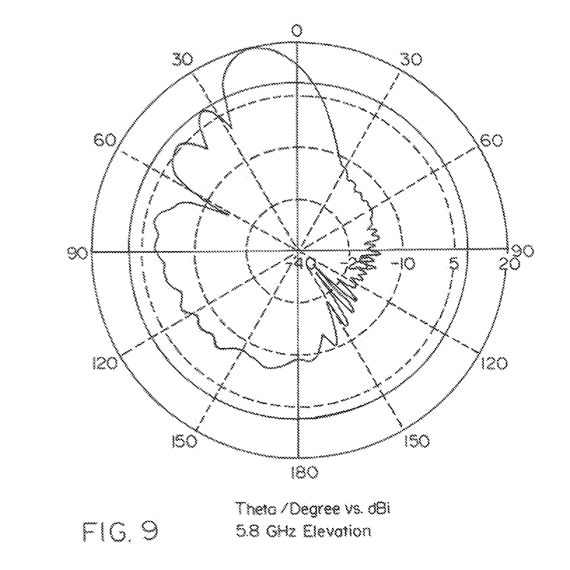

The elevation radiation patterns of the low profile broadband double-ridged horn antenna of FIGS. 3 and 4 are shown in FIGS. 6 through 9 for four different frequencies, namely for 2.4 Ghz, 3.6 GHz, 4.9 GHz and 5.8 GHz.

Low profile broadband double-ridged horn antennas are shown in FIG. 5 being mounted back-to-back to ensure adequate signal reception for instances when the maximum signal may be located behind the antenna. It can be readily observed that the maximum beam intensity in each case occurs at about 15 degrees in elevation angle and that the half power beamwidth is about 15 to 30 degrees depending upon the operating frequency.

Although the present invention has been described with respect to particular embodiments thereof, numerous modifications can be made which are within the scope of the invention set forth in the claims appended hereto. Therefore, the disclosed embodiments should be deemed to be illustrative and not limiting.

What is claimed is:

1. A non-symmetrical, reduced profile, double-ridged, tapered horn antenna having at least one substantially planar surface for support by an underlying support surface of a train or other vehicle; the antenna comprising:
a plurality of interconnected flared horn walls forming a rectangular aperture for transmitting an electromagnetic signal at an angle that is elevated above said support surface;
a first horn wall formed from said substantially planar surface;
a second horn wall non-symmetrically opposed to said first horn l and disposed at a non-zero angular relation relative to said first horn wall;
a pair of congruent side walls interconnecting said first and second horn walls;
a source of electromagnetic excitation coupled by first and second ridges to said first and second horn walls respectively;
said first ridge being symmetrically affixed to said first horn wall and being substantially uniform in height along its length toward said aperture;
said second ridge being symmetrically affixed to said second horn wall and being selectively tapered in height along its length toward said aperture to steer said electromagnetic signal to a desired angle of elevation above said first horn wall.

2. The horn antenna recited in claim 1 wherein said first ridge terminates abruptly into the first horn wall at a location where the distance between said side walls is at least 0.5 wavelengths at the lowest frequency of said electromagnetic signal.

3. The horn antenna recited in claim 1 wherein said second ridge tapers toward and into said second horn wall at a location where the distance between said side walls is at least 0.5 wavelengths at the lowest frequency of said electromagnetic signal.

4. The horn antenna recited in claim 3 wherein said second ridge taper is along an exponentially-shaped path.

5. The horn antenna recited in claim 3 wherein said second ridge taper is along a parabolic-shaped path.

6. The horn antenna recited in claim 3 wherein said second ridge taper is along a linear-shaped path.

7. The horn antenna recited in claim 1 wherein said source of excitation is coupled by a probe extending into said antenna.

8. The horn antenna recited in claim 1 wherein said source of excitation is coupled into said antenna by a waveguide.

9. The horn antenna recited in claim 1 wherein said electromagnetic signal is at a frequency that extends at least as low as 2.4 GHz and at least as high as 5.8 GHz.

10. A horn antenna configured for use on top of a moving train for transmitting and receiving electromagnetic signals elevated in direction above the top of the train;
the antenna comprising:
a plurality of flared planar walls forming a tapered antenna body terminating in a rectangular aperture; a first of said walls configured for resting on said top of said train in substantially surface to surface engagement;
a second of said walls non-symmetrically opposed to said first of aid walls and disposed at a non-zero angular relation relative to said first of said walls;
a pair of congruent side walls interconnecting said first and said second of said walls;
a source of electromagnetic excitation coupled by first and second ridges to said first and second walls respectively;
said first ridge being symmetrically affixed to said first wall and being substantially uniform in height along its length toward said aperture;
said second ridge being symmetrically affixed to said second wall and being selectively tapered in height along its length toward said aperture to steer said electromagnetic signal to a desired angle of elevation above said first wall.

11. The horn antenna recited in claim 10 wherein said first ridge terminates abruptly into the first wall at a location where the distance between said side walls is at least 0.5 wavelengths at the lowest frequency of said electromagnetic signals.

12. The horn antenna recited in claim 10 wherein said second ridge tapers toward and into said second wall at a location where the distance between said side walls is at least 0.5 wavelengths at the lowest frequency of said electromagnetic signals.

13. The horn antenna recited in claim 12 wherein said second ridge taper is along an exponentially-shaped path.

14. The horn antenna recited in claim 12 wherein said second ridge taper is along a parabolic-shaped path.

15. The horn antenna recited in claim 12 wherein said second ridge taper is along a linear-shaped path.

16. The horn antenna recited in claim 10 wherein said source of excitation is coupled by a probe extending into said antenna.

17. The horn antenna recited in claim 10 wherein said source of excitation is coupled into said antenna by a waveguide.

18. The horn antenna recited in claim 10 wherein said electromagnetic signals are at a frequency that extends at least as low as 2.4 GHz and at least as high as 5.8 GHz.
